(19) United States
(12) Patent Application Publication
(10) Pub. No.: US 2008/0212931 A1
(43) Pub. Date: Sep. 4, 2008

(54) Method and System for Integrating and/or Randomly Reproducing Images From an Information Storage Medium

(75) Inventors: Rodolphe Pellerin, Paris (FR); Gilles Delannoy, Paris (FR); Henri-Christophe Ferbus, Sanary Sur Mer (FR); Olivier Covo, Paris (FR)

Correspondence Address: BANNER & WITCOFF, LTD., 1100 13th STREET, N.W., SUITE 1200, WASHINGTON, DC, 20005-4051, US

(73) Assignee: HIGHWAY TELEVISION, PARIS (FR)

(21) Appl. No.: 10/589,344

(22) PCT Filed: Feb. 10, 2005
(86) PCT No.: PCT/FR05/00294

§ 371 Date: Nov. 2, 2007

(30) Foreign Application Priority Data
Feb. 13, 2004 (FR) 0401452

(51) Int. Cl. H04N 7/00

(52) U.S. Cl. 386/46

(57) ABSTRACT

The invention relates to a method for integrating images in an information storage medium. Images of a scene recorded by sensors placed at different locations offering shots at different angles are used for determining chronological series of images for each of the shots of the scene, and these chronological series are recorded on the tracks of the storage medium in a multiplexed or parallel manner. One or more randomly selected algorithms of these chronological series stored on the storage medium is/are determined, and this storage medium is programmed for enabling the successive display of these chronological series in an automatic and random manner by implementing the algorithm(s), the display being configured to stop after a specified time or by manual action.

The present invention relates to a method for integrating images in an information storage medium.

It also relates to a method for reproducing a visual scene on the basis of an information storage medium and a system for reproducing a visual scene using such a method.

It finds a particularly important although not exclusive application in the field of the random and automatic displaying of films recorded on DVD relating more particularly to sports events, concerts or any visual scenes in real time (“live”).

It is also advantageously applicable to the integration of several scenes shot by digital cameras, for example during a family event, which may subsequently be reviewed on a computer or burnt onto a DVD.

Devices making it possible to display from one and the same medium, scenes shot by sensors disposed at different locations are already known.

Such devices, or else the methods that they implement, are rigid.

They do not make it possible, without manual intervention from the user of the display medium, to change the angles from which the scene is displayed.

Admittedly, the rapid advances in information media and in display means associated therewith have to date enabled many possibilities of user access (by way of menus for example) to be integrated.

On the other hand, hitherto the benefit, nor even the possibility had ever been envisaged of randomly accessing one and the same scene shot from various angles, redisplaying it each time in a different and random manner, as if the user were viewing a new film.

Stated otherwise, the idea from which the invention has developed is based on the possibility of automating the successive activation of different picture-taking angles chosen randomly from among several video streams, thereby permitting indefinitely and randomly the viewing of a different film each time although using the same series or sequences of moving images.

With this aim, the invention proposes in particular a method for integrating images in an information storage medium, characterized in that, on the basis of images of a scene that are shot by sensors disposed at different locations giving picture shots taken from different angles,

chronological series of images are determined for each of the picture shots of the scene,
said chronological series are recorded on tracks of said medium in a multiplexed manner or in parallel,
one or more algorithms for randomly choosing these chronological series are determined and stored in said medium,
and said medium is programmed to allow the successive displaying of said chronological series in an automatic and random manner by implementation of the algorithm or algorithms, the display being devised so as to stop after a determined time or by manual action.

Advantageously, the information medium is a DVD disk and/or a computer hard disk and/or a memory card (for example cards known by the names “Compact flash” or “Smart media”).

The invention also proposes a method of reproducing a visual scene on the basis of an information storage medium, characterized in that

on the basis of images of the scene that are shot by sensors disposed at different locations from different picture angles, and recorded on tracks of said medium in a multiplexed manner or in parallel, chronological series of images for each of the tracks of the scene thus stored having been established, and one or more algorithms for randomly choosing these chronological series being stored in said medium,
the successive displaying of said chronological series is carried out in an automatic and random manner by implementation of said algorithm or algorithms, and
the display is stopped after a determined time or by manual action.

Advantageously, recourse is also had to one and/or other of the following provisions:
the successive chronological series are selected randomly from among the various tracks in the chronological order of progress of the visual scene;
a sound score synchronized in time with said scene is reproduced simultaneously with the visual scene;
picture shots that are independent of the scene are added to the display;
a preference constraint is introduced regarding one or more of the angles alternated in an automated and random manner with the others.

The invention also proposes a system implementing the methods mentioned hereinabove.

The invention will be better understood on reading an embodiment given hereinafter by way of nonlimiting example.

The present invention refers to the drawings which accompany it in which:

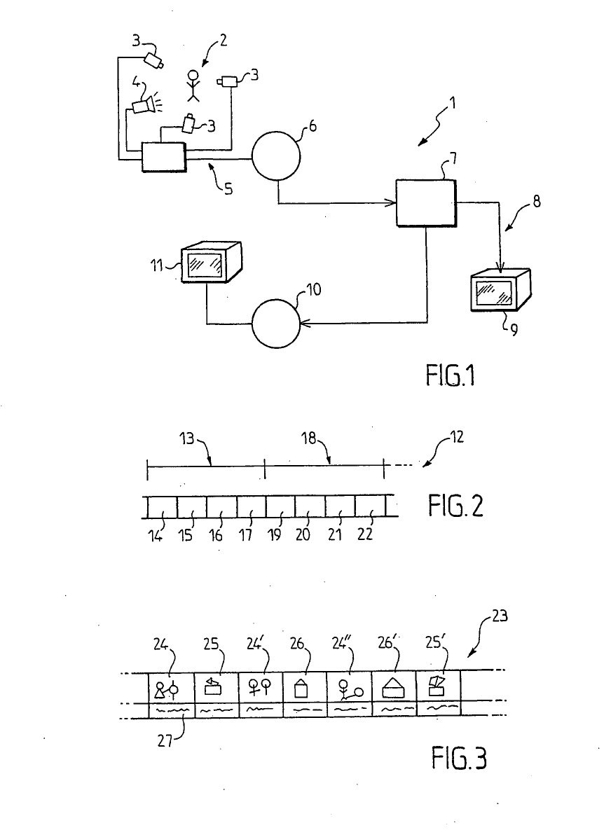

FIG. 1 is a block diagram of a system according to a first embodiment of the invention.

FIG. 2 diagrammatically shows the multiplexed recording of a visual scene shot simultaneously from several angles.

FIG. 3 gives an exemplary chronological series determined in a random manner by an algorithm, according to the invention.

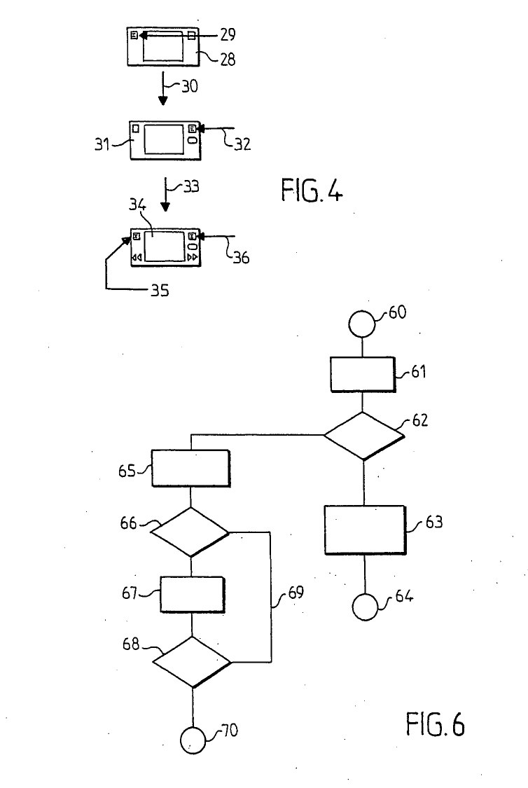

FIG. 4 is a flowchart of the implementation of the method of integrating images according to the invention.

FIG. 5 is a flowchart of the implementation of the corresponding method of reproducing images.

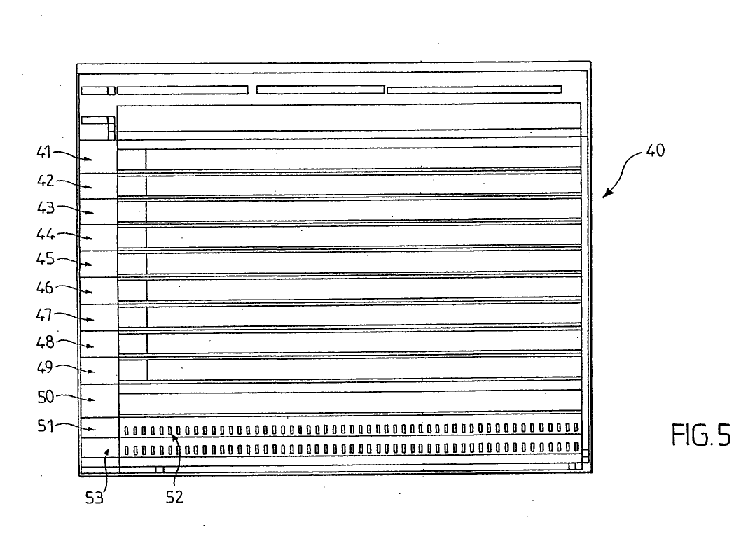

FIG. 6 is a screen copy showing the various tracks of a DVD and the integration of images or the programming corresponding thereto.

FIG. 1 shows a system 1 for integrating and reproducing images from a scene 2 recorded by image sensors 3 for example associated with sound recording means 4.

The sensors 3 are for example digital video cameras disposed in such a way as to be able to shoot the scene 2 from different picture-taking angles.

The images and the sound are recorded by computer means 5 comprising a register 6 for implementing a programming algorithm detailed hereinafter, on a first information storage medium 7 consisting here of the hard disk of a computer 8.

On the basis of this hard disk 7, the multiplexed images and sound are reproduced directly to the user in an automatic and random manner according to the invention via a video screen 9.

In the embodiment more particularly described here but in a wholly nonlimiting manner, a second information medium, in this instance a DVD disk 10 is recorded, and this will allow use and reproduction by screen 11 that is more flexible.

Represented diagrammatically in FIG. 2 is the multiplexed recording 12 of a visual scene shot from different angles, for example four different angles.

The number of angles is not limited. It may also advantageously be nine so as to correspond to the number of video tracks currently adopted for the burning of the DVDs.

For one and the same scene corresponding to a first sequence 13, picture shots 14, 15, 16, 17 of for example 15 images duration each corresponding to different picture angles are stored in a multiplexed manner on the medium.

It should be noted that the multiplexing is dependent on the duration of the “Group of Pictures” (GOP) of the encoding, which in the MPEG-2 standard is counted in fact in terms of images rather than in terms of seconds on DVD.

Next a second sequence 18 of identical or different duration, for example 20 seconds, as a function of the multiplexing programming performed in a manner known per se, of the picture shots 19, 20, 21, 22 situated chronologically and in continuity with respect to the previous picture shots 14, 15, 16, 17, is subsequently stored on the medium, etc.

Each picture shot 14, 15, 16, 17, 19, 20, 21, 22 is cataloged and identified in a register which the program will subsequently draw upon randomly, while complying however with a chronology of the sequences, to construct (cf. FIG. 3) a film 23 of successive pictures corresponding to different picture angles 24, 25, 26, or identical picture angles 24′, 24″, 25′, 26′, etc. obtained in a random manner by virtue of an algorithm for generating random or pseudo-random numbers that is known per se.

A usable algorithm is for example defined in the following manner.

Let f(x)=y (as random function), all the solutions y are equiprobable (there may therefore be repetition) with:

x≧y≧1
xεN+
yεN+

Advantageously and simultaneously a sound tape 27 corresponding to the successive sequences is generated.

The principles of programming of the method of integrating images (“Authoring”) allowing random viewing thereof on a DVD according to an embodiment of the invention will now be described with reference to FIG. 4.

Use is made here of a so-called “Sonic Solution” solution from the American company SONIC. It is composed of three software bricks, dubbed “First Play” 28, “Video Manager” 31 and “Title as multi angle” 34.

The programming is performed as follows.

To begin with, there is the running of the “First Play” brick 28 (generally the introduction of the film). This is a code which makes it possible to determine what the DVD is doing when it is inserted into a reader. It comprises a register 29 and a link 30 to the next brick “Video Manager” 31.

At the end of the “Video Manager” brick, there is provided a “jump Title” function 32 which runs (arrow 33) the brick 34 and hence the film to be displayed.

In the present embodiment, the GPRMs (General Parameters) are variables that can contain only positive integer values from 0 to 99 999.

Just before the film commences, there is then and for example activation of a code 35 entitled “Set Random number X”.

The numeral X corresponds to the number of angles which are actually used during the run (maximum nine angles for the current DVD standard).

This numeral is determined during programming, depending on the desired or available number of angles.

“Random number” corresponds to the name of the GPRM (variable/index number of the angle) “Set Stream Angle by Random parameter” of the “Sonic Solution” program.

Thus the first angle which will be adopted upon the running of the film is determined. If Random=2, the film begins with angle No. 2.

It is important to note here that, with the invention, the programming of the system has to do with the initial commands which make it possible to establish a random starting Angle.

Otherwise, there would always be the same starting angle (be default No. 1).

Once these functions have been initiated, the whole of the programming is done during the progress of the film, the code being integrated in the film.

This code comprises, at the end, a “JumpTitle” link 36 of the type described hereinabove which returns to the beginning of the film and therefore makes it possible to loop the film to infinity.

In this embodiment, when one double-clicks on the image at the center of the “Title” (which corresponds to the programming area), a screen 40 entitled “Presentation editor” appears, corresponding to FIG. 5.

It is in this screen of the Sonic program that the video sources are placed in each of the streams (41 to 49), corresponding to one of the angles, automatically and randomly activated. The sound is placed in the first audio track 50 (eight tracks maximum).

Within the framework of the embodiment of the invention more particularly described here, an area 52 (invisible) on a sequence of video images determined beforehand is created on a so-called “sub-picture” track 51.

It is for example defined that a sequence is equivalent to 15 images. Each “sub-picture” area is moreover programmed at intervals of at least 1 second, thereby making it possible to read the code (note that if the “sub-picture” track were programmed at less than a second, compilation of the DVD would be impossible).

The “sub-picture” track comprises for example images of four colors maximum on top of the video. It also makes it possible to create buttons which serve to make links. This track is constructed manually by a click/drag on the track.

Finally the screen moreover comprises a so-called “action” track 53 linked to the “sub-picture” track and which is filled up when a button is created in the “sub-picture”. It is in said button that the code is contained.

Track 1 is for its part created manually.

According to the embodiment of the invention more particularly described here, and to change angle randomly, it is necessary to create two “sub-pictures”:

One to create the random change and store it in a GPRM (variable).

The other which serves to read the angle corresponding to the GPRM.

Thus a “sub-picture” with a random number (“random”) is alternated with a “sub-picture” with a change of angle, doing so until the end of the film.

More precisely and for example, the first “sub-picture” is for example programmed in the following manner.

By way of a double click on the first “sub-picture”, the editor menu appears, the “sub-picture” is then rendered invisible by default (four colors as alpha to 0).

To proceed with the creation of a button, the tools of the Sonic program are used.

Subsequently, one will double-click on the invisible button programmed created by integrating therein the “Set Random number 9” code (if 9 video streams/angles activated) before going to the second “sub-picture”.

To do this one double-clicks on the next sub-picture.

An invisible button is created anew and the new code is then introduced by double-clicking above. It should be noted that only a single line of code can be placed in a button. This is why a new “sub-picture” is created in which it must read the angle corresponding to the value of the “Random GPRM”: this involves the “Set Stream Angle by Random parameter” function.

Finally, in this embodiment described it is subsequently necessary to manually create all the “sub-pictures”, so as to develop the infinite and random access throughout the length of the film.

It will be noted here that it is therefore possible to activate this function on all or part of a chain of images in a film.

Curiously and in a manner that could not initially be suspected, it is by placing the code on buttons in “sub-pictures” that we obtain neither sound cutoff, nor freezing of the image.

The method of reproducing a visual scene on the basis of images of the scene that are shot by sensors disposed at different locations from different picture angles and recorded on the nine tracks of a DVD in a multiplexed manner will now be described with reference to FIG. 6.

As indicated hereinafter, chronological series of images have been determined and stored in the DVD for each track, an algorithm for random determination being programmed into the DVD.

The DVD being connected at 60, the user then accesses the menu at 61. A test is performed at 62 to ascertain whether the DVD is read normally at 63, until the DVD stops at 64.

Otherwise, the reproduction according to the invention is initiated at 65.

A first choice of a sequence of images (14 in 13) is performed at 66 from among the nine tracks, which image sequence is then projected (operation 67) for a programmed determined time, for example corresponding to 15 images.

A test 68 regarding the end of display is then performed.

If nothing indicates this end, whether it be engendered automatically or manually, a new choice (20′ in 18) of sequence is performed (line 69) from among the sequences of the nine tracks which chronologically follow the previous ones etc. until it stops at 70.

As goes without saying and as results also from the foregoing, the present invention is not limited to the embodiments more particularly described. On the contrary it encompasses all the variants thereof and in particular those where the medium is of a type other than those more particularly described.

1. A method for integrating images in an information storage medium, characterized in that, on the basis of images of a scene that are shot by sensors disposed at different locations giving picture shots taken from different angles,
chronological series of images are determined for each of the picture shots of the scene,
said chronological series are recorded on tracks of said medium in a multiplexed manner or in parallel,
one or more algorithms for randomly choosing these chronological series are determined and stored in said medium,
and said medium is programmed to allow the successive displaying of said chronological series in an automatic and random manner by implementation of the algorithm or algorithms, the display being devised so as to stop after a determined time or by manual action.

2. The method as claimed in claim 1, characterized in that picture shots that are independent of the scene are added to the display.

3. A method of reproducing a visual scene on the basis of an information storage medium, characterized in that
on the basis of images of the scene that are shot by sensors disposed at different locations from different picture angles, and recorded on tracks of said medium in a multiplexed manner or in parallel, chronological series of images for each of the tracks of the scene thus stored having been established, and one or more algorithms for randomly choosing these chronological series being stored in said medium,
the successive displaying of said chronological series is carried out in an automatic and random manner by implementation of said algorithm or algorithms, and
the display is stopped after a determined time or by manual action.

4. The method as claimed in any one of the preceding claims, characterized in that the successive chronological series are selected randomly from among the various tracks in the chronological order of progress of the visual scene.

5. The method as claimed in any one of the preceding claims, characterized in that a sound score synchronized in time with said scene is reproduced simultaneously with the visual scene.

6. The method as claimed in any one of the preceding claims, characterized in that picture shots that are independent of the scene are added to the display.

7. The method as claimed in any one of the preceding claims, characterized in that the information medium is a DVD disk.

8. The method as claimed in any one of the preceding claims, characterized in that a preference constraint is introduced regarding one or more of the angles alternated in an automated and random manner with the others.

9. A system for reproducing a visual scene comprising an information storage medium comprising a plurality of tracks recorded in a multiplexed manner or in parallel with images of the scene that are shot by sensors disposed at different locations from different picture angles, characterized in that, chronological series of images for each of the tracks of the scene thus stored having been established, said medium moreover comprises a register for storing one or more algorithms for randomly choosing these chronological series, said algorithms being devised so as to display said chronological series successively in an automatic and random manner and means of stopping the display after a determined time or by manual action.

10. The system for reproducing a scene as claimed in claim 9, characterized in that the information medium is a DVD.

11. The system as claimed in claim 9, characterized in that the information medium is a computer hard disk.

12. The system as claimed in any one of the preceding claims 9 to 11, characterized in that it comprises means for reproducing simultaneously with the visual scene a sound score synchronized in time with said scene.
